(19) United States
(12) Patent Application Publication
(10) Pub. No.: US 2019/0289847 A1
(43) Pub. Date: Sep. 26, 2019

(54) SUSTAINED RELEASE FIBERS

(71) Applicant: INVISTA TEXTILES (U.K.) LIMITED, Manchester (GB)

(72) Inventor: Natalie Gibson, Wilmington, DE (US)

(21) Appl. No.: 16/334,626

(22) PCT Filed: Aug. 9, 2017
(86) PCT No.: PCT/US17/46090

§ 371 Date: Mar. 19, 2019

Related U.S. Application Data
(60) Provisional application No. 62/379,369, filed on Aug. 25, 2016.

(51) Int. Cl. A01N 25/34; A01N 37/40; A47G 27/02; D01F 8/04; D01F 1/10

(52) U.S. Cl. CPC A01N 25/34; A01N 37/40; A47G 27/02; D10B 2401/13; D01F 1/103; D10B 2503/04; D01F 8/04

(57) ABSTRACT

The present disclosure provides, in certain embodiments, a fiber comprising a core comprising a first polymer and at least active ingredient, wherein the at least one active ingredient is encapsulated by a second polymer; and at least one polymer layer at least partially encapsulating the core. The fiber disclosed herein may be capable of releasing the at least one active ingredient for at least three months. The active ingredient disclosed herein may be a dust mite inhibitor, and may be chosen from a fragrance, an antimicrobial, and a pesticide. Additionally, the fiber disclosed herein may be inserted into a yarn or combine with other textile materials during bulk fiber production or yarn processing, i.e., twisting and heat setting, for use in carpets, bedding, and other home textiles.

### FIELD OF THE INVENTION

The present disclosure is directed to fibers comprising at least one slow-release active component, as well as the use of such fibers to produce articles such as carpets and fabrics.

### BACKGROUND OF THE INVENTION

In the past, many different active ingredients were used to treat fibers. These active ingredients were typically in the form of a liquid spray or a solid powder, and were added to the external surface of the fiber. The addition of the active ingredient could occur to the fiber itself, or to a formed article, such as a fabric or a carpet. These methods of application, however, were inefficient with respect to the amount of active ingredient that needed to be added. Many consumers were concerned about the excessive application of substances, such as a pesticide, that could be harmful to small children and household pets. A need therefore existed to provide an efficient manner for distributing active ingredients into fibers that would require less active ingredient to be applied and/or an increase the efficacy of the active ingredient in the fiber.

### SUMMARY OF THE INVENTION

One of the objectives of the present disclosure is to provide a fiber comprising at least one active ingredient that is capable of providing the sustained release of the at least one active ingredient into the environment surrounding the fiber. These active-ingredient fibers may be inserted into yarn or fiber bundles in various stages of downstream processing for making, for example, textile materials such as carpets, carpet tiles, rugs, bedding materials, and apparel. Textiles produced according to the present disclosure could achieve better durability of the sustained-release fiber due to the incorporation of the active ingredient into the fibers, which could prevent the active ingredient from being worn off by wear and tear.

The active ingredients contemplated by the present disclosure include, for example, fragrances to impart a desired aroma; antimicrobials to treat and/or control undesirable environmental conditions; moisturizing agents, such as palm oils and vitamin E; and pesticides to control, repel and/or mitigate pests, such as insects. It is also contemplated that the disclosed active ingredient can be capable of accomplishing multiple results such as, for example, a fragrance that imparts an aroma and also repels pests.

The pests contemplated by the present disclosure include any insects that are undesirable in a home. One example of such pests that can be found in a home include dust mites, which are members of arachnids family that includes spiders, chiggers and ticks, and are considered to be the most common cause of asthma and allergic symptoms worldwide.

Dust mites thrive in warm, humid environments and they primarily live on dead skin cells regularly shed from humans and their animal pets. Thus, most homes, especially bedding, upholstered furniture, and carpeting, provide an ideal environment for dust mites. As an example, one square yard of carpet can host nearly 100,000 mites.

People who are allergic to dust mites react to proteins within the bodies and feces of the mites. These particles are found mostly in pillows, mattresses, carpeting, and upholstered furniture. Signs of dust mite allergy include sneezing and runny nose or rhinorrhea. Some people with dust mite allergy also experience signs of asthma, such as wheezing and difficulty breathing.

The typical size of dust mite is about 0.010-0.012 inch in length, which is barely visible to the unaided human eye. Due to their small sizes, no matter how clean a home is, dust mites cannot be totally eliminated. For instance, up to 95 percent of mites may remain after vacuuming, because they live deep inside the stuffing of sofas, chairs, mattresses, pillows and carpeting. It may be possible to reduce the number of dust mites applying certain known dust mite inhibitors or repellents such as phenyl salicylate. These chemical agents, however, tend to have high volatility and thus may be effective for only a short period of time when applied in a typical manner, i.e. topical application. For example, phenyl salicylate has been referenced as only having 3-4 months of efficacy at best.

Accordingly, another objective of the present disclosure is to provide a dust mite inhibiting fiber that is capable of providing sustained inhibition and repelling effect against dust mites. A further objective of the present disclosure is to provide a dust mite inhibiting fiber that may be inserted into yarn or fiber bundles in various stages of downstream processing for making textile materials such as carpets and bedding materials.

### BRIEF DESCRIPTION OF DRAWINGS

FIG. 1(A) shows the cross-sectional area of an exemplary dust mite inhibitor and/or repelling fiber, wherein in the core of the fiber the at least one dust mite inhibitor is encapsulated within in the polymer matrix.

FIG. 1(B) shows the cross-sectional area of an exemplary dust mite inhibitor and/or repelling fiber, wherein in the core of the fiber the at least one dust mite inhibitor is further encapsulated with a second polymer matrix different from the polymer matrix of the core.

FIG. 1(C) shows the cross-sectional area of an exemplary dust mite inhibitor and/or repelling fiber, wherein in the core of the fiber the at least one dust mite inhibitor is further encapsulated with a polymer layer or sheath.

FIG. 1(D) shows the cross-sectional area of an exemplary dust mite inhibitor containing corer inserted into a bundle of fibers.

### DETAILED DESCRIPTION

The present disclosure provides a sustained-release fiber comprising a core comprising a first polymer and at least one active ingredient, wherein the at least one active ingredient is encapsulated by a second polymer; and at least one polymer layer at least partially encapsulating the core, wherein the fiber is capable of releasing the at least one active ingredient for at least three months.

The present disclosure further provides a sustained-release fiber comprising: a core consisting essentially of a first polymer and at least one active ingredient, wherein the at least one active ingredient is encapsulated by a second polymer; and at least one polymer layer at least partially encapsulating the core, wherein the fiber is capable of releasing the at least one active ingredient for at least three months.

In an additional embodiment, the present disclosure provides a sustained-release fiber comprising: a core consisting of a first polymer and at least one active ingredient, wherein the at least one active ingredient is encapsulated by a second polymer; and at least one polymer layer at least partially encapsulating the core, wherein the fiber is capable of releasing the at least one active ingredient for at least three months.

A further embodiment of the present disclosure provides a sustained-release fiber comprising: a core comprising a polymer and at least one active ingredient, wherein the core does not comprise a zeolite or silica; and at least one polymer layer at least partially encapsulating the core, wherein the fiber is capable of releasing the at least one active ingredient for at least three months.

The present disclosure provides a sustained-release fiber comprising a core comprising a first polymer and at least one active ingredient chosen from a fragrance, an antimicrobial, and a pesticide, wherein the at least one active ingredient is encapsulated by a second polymer; and at least one polymer layer at least partially encapsulating the core, wherein the fiber is capable of releasing the at least one active ingredient for at least three months.

The present disclosure further provides a sustained-release fiber comprising: a core consisting essentially of a first polymer and at least one active ingredient chosen from a fragrance, an antimicrobial, and a pesticide, wherein the at least one active ingredient is encapsulated by a second polymer; and at least one polymer layer at least partially encapsulating the core, wherein the fiber is capable of releasing the at least one active ingredient for at least three months.

In an additional embodiment, the present disclosure provides a sustained-release fiber comprising: a core consisting of a first polymer and at least one active ingredient chosen from a fragrance, an antimicrobial, and a pesticide, wherein the at least one active ingredient is encapsulated by a second polymer; and at least one polymer layer at least partially encapsulating the core, wherein the fiber is capable of releasing the at least one active ingredient for at least three months.

A further embodiment of the present disclosure provides a sustained-release fiber comprising: a core comprising a polymer and at least one active ingredient chosen from a fragrance, an antimicrobial, and a pesticide, wherein the core does not comprise a zeolite or silica; and at least one polymer layer at least partially encapsulating the core, wherein the fiber is capable of releasing the at least one active ingredient for at least three months.

The present disclosure also provides a sustained-release, dust-mite inhibiting fiber comprising: a core comprising a first polymer and at least one dust mite inhibitor encapsulated by a second polymer; and at least one polymer layer at least partially encapsulating the core; wherein the dust mite inhibiting fiber is capable of releasing the at least one dust mite inhibitor for at least three months. In certain embodiments, the core consists essentially of the first polymer and the at least one dust mite inhibitor encapsulated by the second polymer. In further embodiments, the core consists of the first polymer and the at least one dust mite inhibitor encapsulated by the second polymer.

Additional embodiments of the present disclosure are directed to a sustained-release, dust-mite inhibiting fiber comprising: a core comprising a first polymer and at least one dust mite inhibitor, wherein said core does not comprise zeolites or silica; and at least one polymer layer at least partially encapsulating the core; wherein the dust mite inhibiting fiber is capable of releasing the at least one dust mite inhibitor for at least three months.

The present disclosure also provides a fiber bundle comprising at least one of the sustained-released fiber disclosed herein. In certain embodiments, the fiber bundle comprises from 0.1 to 60 percent by weight of the sustained-released fibers, based on the total weight of the fiber bundle. In more particular embodiments, the fiber bundle comprises the sustained-release fibers in amounts ranging from 0.1 to 50 percent by weight, 0.1 to 40 percent by weight, 0.1 to 30 percent by weight, 0.1 to 20 percent by weight, 0.5 to 60 percent by weight, 0.5 to 50 percent by weight, 0.5 to 40 percent by weight, 0.5 to 30 percent by weight, 0.5 to 20 percent by weight, 1 to 60 percent by weight, 1 to 50 percent by weight, 1 to 40 percent by weight, 1 to 30 percent by weight, 1 to 20 percent by weight, 5 to 60 percent by weight, 5 to 50 percent by weight, 5 to 40 percent by weight, 5 to 30 percent by weight, 5 to 20 percent by weight, 10 to 60 percent by weight, 10 to 50 percent by weight, 10 to 40 percent by weight, 10 to 30 percent by weight, or 10 to 20 percent by weight, based on the total weight of the bundle fiber.

The present disclosure also provides a yarn comprising at least one of the sustained-released fiber disclosed herein. In certain embodiments, the yarn comprises from 0.1 to 60 percent by weight of the sustained-released fibers, based on the total weight of the yarn. In more particular embodiments, the yarn comprises the sustained-release fibers in amounts ranging from 0.1 to 50 percent by weight, 0.1 to 40 percent by weight, 0.1 to 30 percent by weight, 0.1 to 20 percent by weight, 0.5 to 60 percent by weight, 0.5 to 50 percent by weight, 0.5 to 40 percent by weight, 0.5 to 30 percent by weight, 0.5 to 20 percent by weight, 1 to 60 percent by weight, 1 to 50 percent by weight, 1 to 40 percent by weight, 1 to 30 percent by weight, 1 to 20 percent by weight, 5 to 60 percent by weight, 5 to 50 percent by weight, 5 to 40 percent by weight, 5 to 30 percent by weight, 5 to 20 percent by weight, 10 to 60 percent by weight, 10 to 50 percent by weight, 10 to 40 percent by weight, 10 to 30 percent by weight, or 10 to 20 percent by weight, based on the total weight of the yarn.

In further embodiments, the present disclosure provides a fabric material comprising at least one fiber comprising: a core comprising a first polymer and at least one active ingredient chosen from a fragrance, an antimicrobial, and a pesticide, wherein the at least one active ingredient is encapsulated by a second polymer; and at least one polymer layer encapsulating the core, wherein the fiber is capable of releasing the at least one active ingredient for at least three months. In certain embodiments, the core consists essentially of the first polymer and the at least one active ingredient, and in other embodiments, the core consists of the first polymer and the at least one active ingredient.

In further embodiments, the present disclosure provides a fabric material comprising at least one fiber comprising: (1) a core comprising a polymer and at least one active ingredient chosen from a fragrance, an antimicrobial, and a pesticide, wherein the core does not comprise a zeolite or silica; and (ii) at least one polymer layer at least partially encapsulating the core, wherein the fiber is capable of releasing the at least one active ingredient for at least three months.

In further embodiments, the present disclosure provides a fabric material comprising at least one fiber comprising: a core comprising a first polymer and at least one active ingredient chosen from a fragrance, an antimicrobial, and a pesticide, wherein the at least one active ingredient is encapsulated by a second polymer; and at least one polymer layer encapsulating the core, wherein the fiber is capable of releasing the at least one active ingredient for at least three months. In certain embodiments, the core consists essentially of the first polymer and the at least one active ingredient, and in other embodiments, the core consists of the first polymer and the at least one active ingredient.

Also provided herein is a process of making a fabric comprising including from 0.1 to 60 percent by weight of at least one sustained-release fiber comprising: a core comprising a first polymer and at least one active ingredient chosen from a fragrance, an antimicrobial, and a pesticide, wherein the at least one active ingredient is encapsulated by a second polymer; and at least one polymer layer at least partially encapsulating the core, wherein the fiber is capable of releasing the at least one active ingredient for at least three months. In more specific embodiments, In more particular embodiments, the fabric comprises the sustained-release fibers in amounts ranging from 0.1 to 50 percent by weight, 0.1 to 40 percent by weight, 0.1 to 30 percent by weight, 0.1 to 20 percent by weight, 0.5 to 60 percent by weight, 0.5 to 50 percent by weight, 0.5 to 40 percent by weight, 0.5 to 30 percent by weight, 0.5 to 20 percent by weight, 1 to 60 percent by weight, 1 to 50 percent by weight, 1 to 40 percent by weight, 1 to 30 percent by weight, 1 to 20 percent by weight, 5 to 60 percent by weight, 5 to 50 percent by weight, 5 to 40 percent by weight, 5 to 30 percent by weight, 5 to 20 percent by weight, 10 to 60 percent by weight, 10 to 50 percent by weight, 10 to 40 percent by weight, 10 to 30 percent by weight, or 10 to 20 percent by weight, based on the total weight of the fabric.

In additional embodiments, the present disclosure provides a carpet comprising yarns comprising at least one fiber comprising: (1) a core comprising a polymer and at least one active ingredient chosen from a fragrance, an antimicrobial, and a pesticide, wherein the core does not comprise a zeolite or silica; and (ii) at least one polymer layer at least partially encapsulating the core, wherein the fiber is capable of releasing the at least one active ingredient for at least three months. In certain embodiments, the core consists essentially of the first polymer and the at least one active ingredient, and in other embodiments, the core consists of the first polymer and the at least one active ingredient.

Also provided herein is a carpet comprising yarns comprising: at least one fiber comprising (1) a core comprising a polymer and at least one active ingredient chosen from a fragrance, an antimicrobial, and a pesticide, wherein the core does not comprise a zeolite or silica; and (ii) at least one polymer layer at least partially encapsulating the core, wherein the fiber is capable of releasing the at least one active ingredient for at least three months.

Also provided herein is a process of making a carpet comprising including from 0.1 to 5 percent by weight of at least one sustained-release fiber comprising: a core comprising a first polymer and at least one active ingredient chosen from a fragrance, an antimicrobial, and a pesticide, wherein the at least one active ingredient is encapsulated by a second polymer; and at least one polymer layer at least partially encapsulating the core, wherein the fiber is capable of releasing the at least one active ingredient for at least three months. In more particular embodiments, the carpet comprises the sustained-release fibers in amounts ranging from 0.1 to 4 percent by weight, 0.1 to 3 percent by weight, 0.1 to 2 percent by weight, 0.1 to 1 percent by weight, 0.5 to 5 percent by weight, 0.5 to 4 percent by weight, 0.5 to 3 percent by weight, 0.5 to 2 percent by weight, 0.5 to 1 percent by weight, 1 to 5 percent by weight, 1 to 4 percent by weight, 1 to 3 percent by weight, 1 to 2 percent by weight, 2 to 5 percent by weight, or 3 to 5 percent by weight, based on the total weight of the carpet.

In certain embodiments, the fiber is capable of releasing the at least one active ingredient, such as a dust mite inhibitor, for an extended period of time chosen from at least three months, at least four months, at least five months, at least six months, at least seven months, at least eight months, at least nine months, at least ten months, at least eleven months, and at least one year. In certain embodiments, the core comprising a polymer matrix and at least active ingredient does not comprise any porous substance, such as silica or a zeolite, for containing the at least active ingredient.

In some embodiments, the dust mite inhibiting and/or repelling fiber has a denier ranging from 5 to 30, such as, for example, from 5 to 25, from 5 to 20, from 5 to 15, from 8 to 30, from 8 to 25, from 8 to 20, from 8 to 15, from 10 to 30, from 10-25, from 10 to 20, from 15 to 30, or from 15 to 25. The unit “denier” is defined as the mass in grams per 9000 meters of fiber.

As some of the dust mite inhibitors may exhibit repelling effects against other members of arachnids family such as spiders, fleas, and ticks (e.g., literature shows phenyl salicylate is effective against dust mites as well as fleas and ticks). Thus, in some embodiments, the dust mite inhibiting and/or repelling fiber disclosed herein may also exhibit an inhibitory effect against other members of arachnids family such as spiders, fleas, and ticks.

The dust mite inhibiting and/or repelling fiber disclosed herein comprises a core comprising a polymer matrix and at least one dust mite inhibitor.

In some embodiments, the at least one dust mite inhibitor present in the core may be chosen from synthetic miticides and natural miticides.

In one embodiment, the at least one dust mite inhibitor may be chosen from phenyl salicylate, methyl salicylate, benzyl salicylate, benzyl benzoate, trolamine salicylate, salicylic acid, ethyl salicylate, phenethyl salicylate, benzyl phthalate and benzyl butyl phthalate. In another embodiment, the at least one dust mite inhibitor may be chosen from acaricides such as the ones disclosed in U.S. Pat. No. 4,800,196, for example, diphenylamine, methyl β-naphthyl ketone, coumarin, phenetyl benzoate, N-fluorodichloromethyl-thio-cyclohexene-dicarboxyimide, p-nitrobenzoic acid methyl ester, p-chlorometaxylenol, α-bromocinnamic aldehyde, 2,5-dichloro-4-bromophenol, N,N-dimethyl-N′-tryl-N′-(fluorodichloromethylthio)-sulfamide, Z-phenyl-phenol, sodium Z-phenyl-phenolate, 5-chloro-2-methyl-4-isothiazoline-3-one, 2-methyl-4-isothioazoline-3-one, and benzimidazolyl methyl-carbamate.

In one embodiment, the at least one dust mite inhibitor may be chosen from essential oils including but not limited to, caraway oil, chenopodium oil, cinnamon oil, clove oil, eucalyptus oil, garlic oil, geranium oil, lavender oil, lemon grass oil, matrecary oil, peppermint oil, rose oil, rosemary oil, fennel oil, and thyme oil. For example, the at least one dust mite inhibitor may be chosen from clove oil, matrecary oil, chenopodium oil, fennel oil, eucalyptus oil, peppermint oil, rosemary oil, and lavender oil. The at least one dust mite inhibitor may also be chosen from synthetic fragrances including, but not limited to, linalool, tonka bean, and methylbenzodioxepinone.

In another embodiment, the at least one dust mite inhibitor may be chosen from terpenes including, but not limited to, cinnamaldehyde, chlorothymol, citronellol, and menthol.

The amount of the at least one dust mite inhibitor present in the core of the fiber may vary depending on various factors such as the properties of the dust mite inhibitor, the polymer matrix present in the core, and the polymer layer that partially or fully encapsulating the core; the desired release rate of the inhibitor from the fiber; and the intended use of the fiber.

In some embodiments, the at least one dust mite inhibitor may be present in the core in an amount ranging from about 0.5 to about 20 percent by weight, based on the total weight of the core. In more particular embodiments, the at least one dust mite inhibitor is present in the core in amounts ranging from 0.5 to 15 percent by weight, 0.5 to 10 percent by weight, 0.5 to 5 percent by weight, 1 to 20 percent by weight, 1 to 15 percent by weight, 1 to 10 percent by weight, 1 to 5 percent by weight, 5 to 20 percent by weight, 5 to 15 percent by weight, 5 to 10 percent by weight, or 10 to 20 percent by weight, based on the total weight of the core.

In some embodiments, the polymer matrix present in the core of the fiber may comprise at least one polymer chosen from polyolefins, polyesters, polyamides, polycarbonates, polycaprolactone, and polyurethanes.

As a non-limiting example, polyolefins may be chosen from polyethylene, polypropylene, polystyrene, polyacrylate, polyisoprene, polymethacrylate, polybutene, poly(l-pentene), and polymethylpentene.

Also as a non-limiting example, polyesters may be chosen from polyethylene terephthalate (PET), polybutylene terephthalate (PBT), polytrimethylene terephthalate (PTT), polyethylene naphthalate (PEN), polylactic acid (PLA), polyglycolic acid (PGA), polycaprolactone (PCL), and polybutylene succinate (PBS).

Further as a non-limiting example, polyamides may be chosen from nylon-6, nylon-6,6, nylon-12, and Kevlar®.

In some embodiments, the polymer matrix may comprise copolymers such as polyethylene/vinyl acetate copolymers.

In some embodiments, the polymer matrix is thermally stable and extrudable under the conditions required for encapsulation with at least one polymer layer.

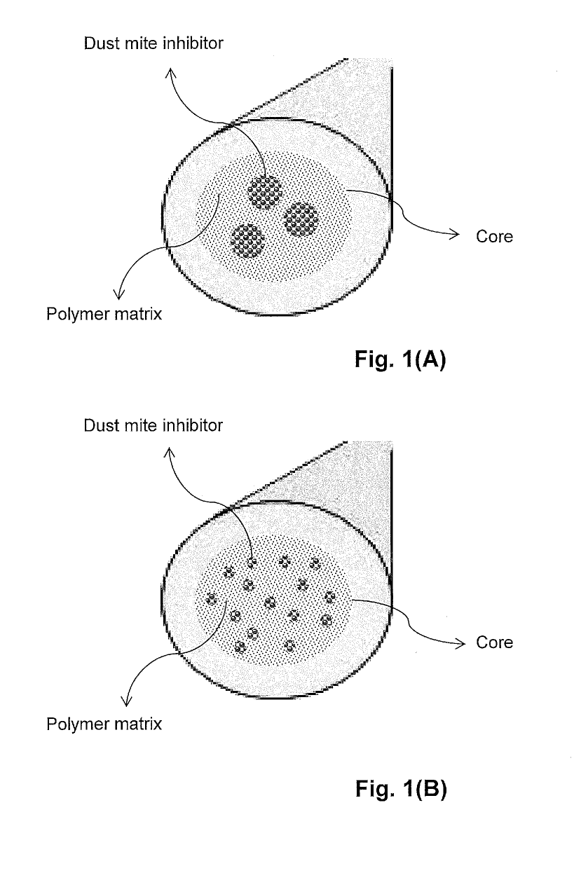

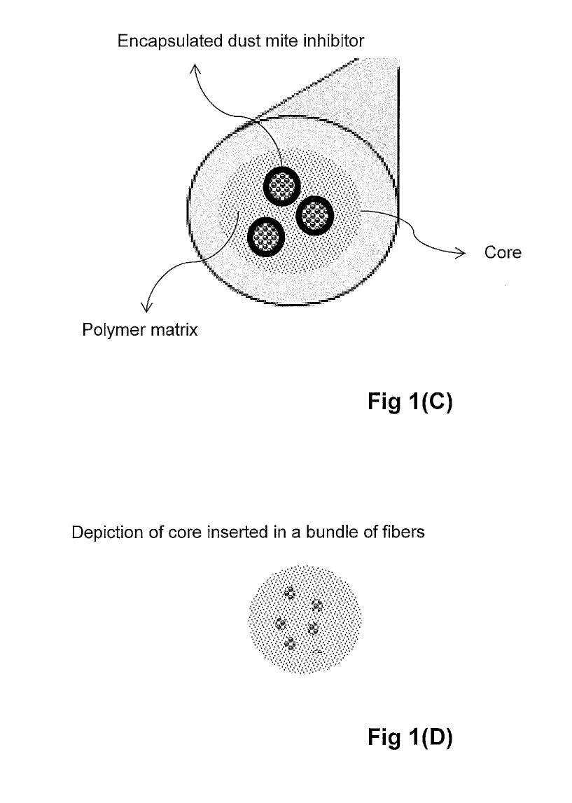

In some embodiments, the at least one dust mite inhibitor present in the core of the fiber may be dispersed freely in the polymer matrix as shown in FIG. 1(A).

In some embodiments, the at least one dust mite inhibitor present in the core of the fiber may be further encapsulated in a second polymer matrix different from the polymer matrix of the core as shown in FIG. 1(B).

In some embodiments, the at least one dust mite inhibitor present in the core of the fiber may be further encapsulated by a second polymer layer or sheath different from the polymer matrix of the core as shown in FIG. 1(C).

In further embodiments, the at least one dust mite inhibitor present in the core of the fiber is contained a second polymer matrix different from the polymer matrix of the core, wherein the fiber is included in a bundle of fibers.

The second polymer layer used to encapsulate the at least one dust mite inhibitor may comprise at least one polymer chosen from polyolefins, polyesters, polyamides, polycarbonates, and polyurethanes.

In one embodiment, the second polymer layer may be different from the polymer matrix in terms of the types of polymeric material (e.g., polyolefin versus polyamide) or in terms of the properties (e.g., both the polymer matrix and the second polymer layer may comprise polyethylenes but one comprises a high-density polyethylene and the other comprises a low-density polyethylene).

In one embodiment, the second polymer layer used to encapsulate the at least one dust mite inhibitor may be the same as the polymer layer encapsulating the core.

In one embodiment, the second polymer layer used to encapsulate the dust mite inhibitor may be different from the polymer layer encapsulating the core in terms of the types of polymeric material (e.g., polyolefin versus polyamide) or in terms of the properties (e.g., both polymer layers may be chosen from polyethylenes but one is a high-density polyethylene and the other is a low-density polyethylene).

In one embodiment, the core of the fiber may be prepared from Slow-Release-Oil-in-Polymer-Emulsion (SROPE) from Kuraray Living Co., Ltd., which contains encapsulated dust mite inhibitor. In certain embodiments, the dust mite inhibitor is chosen from oils which are liquid at 100° C., or lower, and are containing in an oil-in-polymer emulsion.

In some embodiments, the core may have any arbitrary cross sectional shape, such as quadrilateral shapes, triangle shapes, regular or irregular polygon shapes.

In some embodiments, the volume of the core in the fiber needs only be sufficient to provide dust mite inhibition and/or repelling effect.

In some embodiments, the core may further comprise at least one additive chosen from, as non-limiting examples, fragrances, antibacterial agents, antifungal agents, flame resistant agents, ultraviolet absorbents, anti-oxidants, plasticizers, pigments, and dyes.

In addition to the core, the dust mite inhibiting and/or repelling fiber disclosed herein further comprises at least one polymer layer, which may partially or fully encapsulate the core.

In some embodiments, the at least one polymer layer may comprise at least one polymer chosen from polyolefins, polyesters, polyamides, polycarbonates, polyurethanes, polyacrylics, and polylactic acid fibers.

As a non-limiting example, the at least one polymer layer may be chosen from condensation polyamides of diamines and dicarboxylic acid and those of amino acids. Also as a non-limiting example, the at least one polymer layer may be chosen from condensation polyesters, such as those of terephthalic or isophthalic acids and lower glycols such as ethylene glycol, tetramethylene glycol and hexahydro-p-xylene diol, and poly(acrylonitriles). Further as a non-limiting example, the at least one polymer layer may be chosen from nylon-6, nylon-6,6, and nylon-12.

In one embodiment, the at least one polymer layer may be chosen from polyamides such as polybutyramide, polycaproamide, polydodecanoamide, poly(hexamethylene adipamide), poly(hexamethylene sebacamide), poly(hexamethylene dodecanedioamide), the polyamide from bis(4-aminocyclohexyl methane or bis(4-aminocyclohexyl)ethane and dodecanedioic acid, poly(p-xylene adipamide), poly(p-xylene dodecanedioamide). Also in one embodiment, the at least one polymer layer may be chosen from copolymers from appropriately chosen lactams, or corresponding aminoacids, diamines, and dibasic acids of the above homopolymers.

Further in one embodiment, the at least one polymer layer may be chosen from polyesters such as poly(ethylene terephthalate), poly(trimethylene terephthalate), poly(tetramethylene terephthalate), poly(ethylene terephthalate/isophthalate) (85/15), poly(ethylene terephthalate/hexahydroterephthalate) (90/10), poly(hexahydro-p-xylylene terephthalate), terephthalate copolyesters containing an aliphatic dicarboxylic acid constituent (for example, terephthalate/adipate and terephthalate/glutarate copolyesters), and terephthalate copolyesters containing a branched-chain glycol constituent (for example, ethylene/2,2-dimethylpropylene terephthalate copolyesters).

In one embodiment, the at least one polymer layer may be chosen from polyolefins such as polyethylene, polypropylene, polystyrene, polyacrylate, polyisoprene, polymethacrylate, polybutene, poly(l-pentene), and polymethylpentene.

The amount of the at least one polymer layer may vary depending on the properties of the dust mite inhibitor, the polymer matrix present in the core, and the polymer layer that partially or fully encapsulating the core, and the intended use of the fiber.

In some embodiments, the at least one polymer layer that partially or fully encapsulating the core may be present in an amount ranging from 2 to 60% by weight relative to the total weight of the fiber. In more particular embodiments, the at least one polymer layer is present in amounts ranging from 2 to 50 percent by weight, 2 to 40 percent by weight, 2 to 30 percent by weight, 2 to 20 percent by weight, 2 to 10 percent by weight, 5 to 60 percent by weight, 5 to 50 percent by weight, 5 to 40 percent by weight, 5 to 30 percent by weight, 5 to 20 percent by weight, 5 to 10 percent by weight, 10 to 60 percent by weight, 10 to 50 percent by weight, 10 to 40 percent by weight, 10 to 30 percent by weight, 10 to 20 percent by weight, 15 to 60 percent by weight, 15 to 50 percent by weight, 15 to 40 percent by weight, 15 to 30 percent by weight, 20 to 60 percent by weight, 20 to 50 percent by weight, 20 to 40 percent by weight, or 20 to 30 percent by weight, based on the total weight of the fiber.

In some embodiments, the configuration of the at least one polymer layer and the core of the fiber may be round or non-round, eccentric or concentric sheath/core, and combinations thereof. For example, in one embodiment, the core and the polymer layer have a concentric configuration such as the ones depicted in FIG. 1(A), 1(B), or 1(C), which may allow the polymeric layer to provide maximum protection and hiding of the core.

Encapsulating the core with at least one polymer layer may be accomplished by conventional processes for making sheath-core fibers such as the ones disclosed in U.S. Pat. Nos. 3,803,453 or 4,145,473. In some embodiments, depending on the volatility of the at least one dust mite inhibitor, the stability of the polymer matrix in the core, the extrudability of the core material, adjustments may need to be made to those conventional sheath-core processes, for example, temperatures at the core extruder or core extruder speeds may need to be lowered or raised.

In some embodiments, the dust mite inhibiting and/or repelling fiber disclosed herein can be inserted into fiber bundles or yarns in downstream processes, thereby creating a wide range of dust mite inhibiting products, including but not limited to carpets, pillows, duvets, throws, mattresses, upholstery, and curtains. For example, in one embodiment, the dust mite inhibiting and/or repelling fiber disclosed herein can be inserted into fiber bundles or yarns, and the resulting fiber bundles or yarn can then be further tufted or knitted using normal processing techniques.

In some embodiments, the dust mite inhibiting and/or repelling fibers disclosed herein may also be capable of providing dust mite repelling effects in all types of textile including knitted, tufted, woven, and nonwoven textiles. They may also be subjected to all types of textile processing including crimping, texturing, scouring, bleaching, etc.

Thus, the present disclosure also provides a bundle of fibers comprising at least one dust mite inhibiting and/or repelling fiber disclosed herein.

In some embodiments, the dust mite inhibiting and/or repelling fiber may be present in an amount ranging from 0.1 to 60% by weight, relative to the total weight of the bundle of fibers. In certain embodiments, the dust mite inhibiting and/or repelling fiber is present in the bundle of fibers in amounts ranging from 0.1 to 50 percent by weight, 0.1 to 40 percent by weight, 0.1 to 30 percent by weight, 0.1 to 20 percent by weight, 0.5 to 60 percent by weight, 0.5 to 50 percent by weight, 0.5 to 40 percent by weight, 0.5 to 30 percent by weight, 0.5 to 20 percent by weight, 1 to 60 percent by weight, 1 to 50 percent by weight, 1 to 40 percent by weight, 1 to 30 percent by weight, 1 to 20 percent by weight, 5 to 60 percent by weight, 5 to 50 percent by weight, 5 to 40 percent by weight, 5 to 30 percent by weight, 5 to 20 percent by weight, 10 to 60 percent by weight, 10 to 50 percent by weight, 10 to 40 percent by weight, 10 to 30 percent by weight, or 10 to 20 percent by weight, based on the total weight of the bundle of fibers. As a non-limiting example, the mite inhibiting and/or repelling fiber disclosed herein may be inserted into a bulk continuous filament (BCF) fiber bundle in an amount ranging from 1.4% to 1.8%.

In some embodiments, the dust mite inhibiting and/or repelling fiber may be combined with other filaments or fibers during any appropriate step in yarn production (e.g., spinning, drawing, texturing, plying, rewinding, yarn spinning), or during fabric manufacture.

Thus, the present disclosure further provides a fabric material comprising at least one dust mite inhibiting and/or repelling fiber as disclosed above and at least one textile chosen from animal textiles, plant textiles, and synthetic textiles.

As a non-limiting example, the animal textiles may be chosen from wools and silks. Also as a non-limiting example, the plant textiles are chosen from cotton, jute, flax, and hemp. Further as a non-limiting example, the synthetic textiles are chosen from polyolefins, polyesters, polyamides, polycarbonates, polyurethanes, and carbon fibers.

In some embodiments, the dust mite inhibiting and/or repelling fiber may be present in an amount sufficient to allow the fabric material to inhibit the growth of dust mite and/or repel dust mite for at least at least three months.

In some embodiments, the dust mite inhibiting and/or repelling fiber disclosed herein may be present in an amount ranging from [please provide], relative to the total weight of the fabric material.

### EXAMPLES

### Example 1

### Materials

Sheath Materials: Nylon 6-6 (80-90 wt %) from INVISTA, containing nylon 6(3-9%), TiO2 (1-8%), polystyrene (1-2%)

Core Materials: SROPE-DZ from Kuraray Living Co. Ltd., Japan, which contained 20 wt. % phenyl salicylate encapsulated using a polyethylene/polypropylene-polystyrene block copolymer and distributed in a polyethylene (PE) matrix.

When analyzed with thermal gravimetric analysis (TGA), it was observed that SROPE-DZ lost 14.91% of its weight at 170° C. for 20 minutes, which was likely due to the loss of phenyl salicylate. When the temperature increased to 285° C., a 36.8 wt. % loss was observed, which was likely due to both the loss of phenyl salicylate and some degradation of polyethylene matrix.

### Preparation:

To prevent or reduce the loss of phenyl salicylate or degradation of polyethylene matrix, the core extruder temperature was adjusted. The extruder was comprised of 3 zones. Zone 1, cooled by water, was left untouched; Zone 2 was reduced from 125° C. to 116° C., and Zone 3 was reduced from 264° C. to 220° C. Achieving this temperature in Zone 3 was difficult as the temperature radiating off the heating block (where nylon sheath and core come together) would cause heat transfer to Zone 3 in the core extruder. Thus, to achieve the desired temperature, the heater in Zone 3 was turned off and the insulation around the pipes was opened. During cooling, LLDPE (Aspun 6850A) was run through the lines.

When the desired temperatures of the extruder were reached, the SROPE-DZ masterbatch (20% phenyl salicylate) was added to the core hopper undiluted. Core extruder speeds had to be optimized to spin the material and eventually a metering pump speed of 59 Hz or 1.44 rpm was used.

The drawn yarn properties are:

Tenacity=1.952;

Elongation, %=307.345;

Denier=19.996;

Denier per filament=9.998.

Phenyl salicylate has a light medicinal smell. However, no smell was detected in the air during quenching or on the final core-sheath fiber until 3 days after processing.

The resulting fiber was further inserted during twisting in Dalton. No problems or complications came about during twisting or heat setting with the inserted filament. The material was subsequently tufted into carpet with, also without any complication.

### Comparative Fibers:

SROPE-DZ, used without dilution or diluted to 0.15 to 10 wt % (0.3-2.0 wt. % phenyl salicylate actives) with polypropylene, was spun in Dalton without the sheath material.

The blend was extruded into a 770 denier fiber bundle using 108 filament count trilobal spinneret and had a draw ratio of 3.01. Fibers were then collected and processed into a 2-ply yarn with 6.75 twists per inch. Afterwards carpets were tufted into a looped construction using 1 SROPE-DZ containing yarn in a 1 in 2 and 1 in 8 end construction. The comparative fibers, prepared without the sheath material, had a detectable smell of phenyl salicylate even with the one prepared from diluted SROPE-DZ at a concentrations of 0.3 wt %. Tubes of the fiber kept between 73-78° C. were analyzed for this scent 5 months after processing. Bagged tubes still kept this light scent. Un-bagged tubes had carried a significantly softer scent, but nonetheless, was still present.

The results indicates that adding a layer of the sheath material for encapsulating the SROPE-DZ as the core could be used to control the release rates of volatile chemicals such as phenyl salicylate, thereby prolonging the effects of dust mite inhibitors.

What is claimed is:

1. A fiber comprising:
a core comprising a first polymer and at least one active ingredient, wherein the at least one active ingredient is encapsulated by a second polymer; and
at least one polymer layer at least partially encapsulating the core,
wherein the fiber releases the at least one active ingredient for at least three months.

2. The fiber according to claim 1, wherein the active ingredient is chosen from a fragrance, an antimicrobial, and a pesticide.

3. The fiber according to claim 1, wherein the second polymer is dispersed in a first polymer matrix.

4. The fiber according to claim 1, wherein the at least active ingredient is chosen from phenyl salicylate, methyl salicylate, benzyl salicylate, benzyl benzoate, trolamine salicylate, salicylic acid, ethyl salicylate, phenethyl salicylate, benzyl phthalate and benzyl butyl phthalate The fiber according to claim 1, wherein the at least one active ingredient is chosen from clove oil, matrecary oil, chenopodium oil, fennel oil, eucalyptus oil, peppermint oil, rosemary oil, lavender oil, caraway oil, cinnamon oil, garlic oil, geranium oil, lemon grass oil, rose oil, and thyme oil.

5. The fiber according to claim 1, wherein the first polymer and the at least one polymer layer are different polymers.

6. The fiber according to claim 1, wherein the first polymer comprises at least one polymer chosen from polyolefins, polyesters, polyamides, polycarbonates, and polyurethanes.

7. The fiber according to claim 1, wherein the first polymer comprises at least one polymer chosen from polyethylene, polypropylene, polyisoprene, polybutene, polystyrene, and polymethacrylate.

8. The fiber according to claim 1, wherein the at least one polymer layer comprises at least one polymer chosen from polyolefins, polyesters, polyamides, polycarbonates, and polyurethanes.

9. The fiber according to claim 1, wherein the at least one polymer layer comprises at least one polymer chosen from nylon-6, nylon-6,6, and nylon-12.

10. The fiber according to claim 1, where in second polymer comprises a polyurethane.

11. The fiber according to claim 1, wherein the first polymer comprises polyethylene, the second polymer comprises a polyurethane, and the at least one polymer layer comprises a nylon.

12. The fiber according to claim 1, wherein the at least one active ingredient is present in the core in an amount ranging from 0.5 to 20 weight percent, based on the total weight of the core.

13. A yarn comprising at least one fiber according to claim 1.

14. The yarn according to claim 13, wherein fibers according to claim 1 comprise at least 0.5% by weight of the total weight of the yarn.

15. An article of manufacture comprising the yarn according to claim 13.

16. An article of manufacture comprising the yarn according to claim 14.

17. A dust mite inhibiting fiber comprising:
a core comprising a first polymer and at least one dust mite inhibitor encapsulated by a second polymer; and
at least one polymer layer at least partially encapsulating the core;
wherein the dust mite inhibiting fiber releases the at least one dust mite inhibitor for at least three months.

18. A dust mite inhibiting fiber comprising:
a core comprising a first polymer and at least one dust mite inhibitor, wherein said core does not comprise zeolites or silica; and
at least one polymer layer at least partially encapsulating the core;
wherein the dust mite inhibiting fiber releases the at least one dust mite inhibitor for at least three months.

19. A fabric material comprising:
at least one fiber comprising
a) a core comprising a first polymer and at least one active ingredient chosen from a fragrance, an antimicrobial, and a pesticide, wherein the at least one active ingredient is encapsulated by a second polymer; and
b) at least one polymer layer encapsulating the core;
wherein the fiber releases the at least one active ingredient for at least three months.

20. The fabric material according to claim 19, wherein the second polymer is dispersed in a first polymer matrix.

21. The fabric material according to claim 19, wherein the at least active ingredient is chosen from phenyl salicylate, methyl salicylate, benzyl salicylate, benzyl benzoate, trolamine salicylate, salicylic acid, ethyl salicylate, phenethyl salicylate, benzyl phthalate and benzyl butyl phthalate.

22. The fabric material according to claim 19, wherein the at least one active ingredient is chosen from clove oil, matrecary oil, chenopodium oil, fennel oil, eucalyptus oil, peppermint oil, rosemary oil, lavender oil, caraway oil, cinnamon oil, garlic oil, geranium oil, lemon grass oil, rose oil, and thyme oil.

23. The fabric material according to claim 19, wherein the first polymer and the at least one polymer layer are different polymers.

24. The fabric material according to claim 19, wherein the first polymer comprises at least one polymer chosen from polyolefins, polyesters, polyamides, polycarbonates, and polyurethanes.

25. The fabric material according to claim 19, wherein the first polymer comprises at least one polymer chosen from polyethylene, polypropylene, polyisoprene, polybutene, polystyrene, and polymethacrylate.

26. The fabric material according to claim 19, wherein the at least one polymer layer comprises at least one polymer chosen from polyolefins, polyesters, polyamides, polycarbonates, and polyurethanes.

27. The fabric material according to claim 19, wherein the at least one polymer layer comprises at least one polymer chosen from nylon-6, nylon-6,6, and nylon-12.

28. The fabric material according to claim 19, where in second polymer comprises a polyurethane.

29. The fabric material according to claim 19, wherein the first polymer comprises polyethylene, the second polymer comprises a polyurethane, and the at least one polymer layer comprises a nylon.

30. The fabric material according to claim 19, wherein the at least one active ingredient is present in the core in an amount ranging from 0.5 to 20 weight percent, based on the total weight of the core.

31. The fabric material according to claim 19, further comprising at least one textile chosen from animal textiles, plant textiles, and synthetic textiles.

32. The fabric material according to claim 19, wherein the animal textiles are chosen from wools and silks.

33. The fabric material according to claim 19, wherein the plant textiles are chosen from cotton, jute, flax, and hemp.

34. The fabric material according to claim 19, wherein the synthetic textiles are chosen from polyolefins, polyesters, polyamides, polycarbonates, polyurethanes, and carbon fibers.

35. A carpet comprising yarns comprising at least one fiber comprising
a) a core comprising a first polymer and at least one active ingredient chosen from a fragrance, an antimicrobial, and a pesticide, wherein the at least one active ingredient is encapsulated by a second polymer; and
b) at least one polymer layer encapsulating the core;
wherein the fiber releases the at least one active ingredient for at least three months.

36. The carpet according to claim 35, wherein the second polymer is dispersed in a first polymer matrix.

37. The carpet according to claim 35, wherein the yarn comprises from 15 to 30 percent by weight of the at least one fiber.

38. The carpet according to claim 35, wherein the at least one active ingredient is a dust mite inhibitor.

39. The carpet according to claim 35, wherein the at least active ingredient is chosen from phenyl salicylate, methyl salicylate, benzyl salicylate, benzyl benzoate, trolamine salicylate, salicylic acid, ethyl salicylate, phenethyl salicylate, benzyl phthalate and benzyl butyl phthalate.

40. The carpet according to claim 35, wherein the at least one active ingredient is chosen from clove oil, matrecary oil, chenopodium oil, fennel oil, eucalyptus oil, peppermint oil, rosemary oil, lavender oil, caraway oil, cinnamon oil, garlic oil, geranium oil, lemon grass oil, rose oil, and thyme oil.

41. The carpet according to claim 35, wherein the first polymer and the at least one polymer layer are different polymers.

42. The carpet according to claim 35, wherein the first polymer comprises at least one polymer chosen from polyolefins, polyesters, polyamides, polycarbonates, and polyurethanes.

43. The carpet according to claim 35, wherein the first polymer comprises at least one polymer chosen from polyethylene, polypropylene, polyisoprene, polybutene, polystyrene, and polymethacrylate.

44. The carpet according to claim 35, wherein the at least one polymer layer comprises at least one polymer chosen from polyolefins, polyesters, polyamides, polycarbonates, and polyurethanes.

45. The carpet according to claim 35, wherein the at least one polymer layer comprises at least one polymer chosen from nylon-6, nylon-6,6, and nylon-12.

46. The carpet according to claim 35, where in second polymer comprises a polyurethane.

47. The carpet according to claim 35, wherein the first polymer comprises polyethylene, the second polymer comprises a polyurethane, and the at least one polymer layer comprises a nylon.

48. The carpet according to claim 35, wherein the at least one active ingredient is present in the core in an amount ranging from 0.5 to 20 weight percent, based on the total weight of the core.

49. The carpet according to claim 35, further comprising at least one textile chosen from animal textiles, plant textiles, and synthetic textiles.

50. The carpet according to claim 35, wherein the animal textiles are chosen from wools and silks.

51. The carpet according to claim 35, wherein the plant textiles are chosen from cotton, jute, flax, and hemp.

52. The carpet according to claim 35, wherein the synthetic textiles are chosen from polyolefins, polyesters, polyamides, polycarbonates, polyurethanes, and carbon fibers.

53. A process of making a carpet comprising including from 01 to 5 percent by weight of at least one sustained-release fiber comprising:
a core comprising a first polymer and at least one active ingredient chosen from a fragrance, an antimicrobial, and a pesticide, wherein the at least one active ingredient is encapsulated by a second polymer; and
at least one polymer layer at least partially encapsulating the core,
wherein the fiber releases the at least one active ingredient for at least three months.

54. A process of making a fabric comprising including from 0.1 to 60 percent by weight of at least one sustained-release fiber comprising:
a core comprising a first polymer and at least one active ingredient chosen from a fragrance, an antimicrobial, and a pesticide, wherein the at least one active ingredient is encapsulated by a second polymer; and
at least one polymer layer at least partially encapsulating the core,
wherein the fiber releases the at least one active ingredient for at least three months.
